(19) United States
(12) Patent Application Publication
(10) Pub. No.: US 2017/0017695 A1
(43) Pub. Date: Jan. 19, 2017

(54) QUESTION AND ANSWER INFORMATION PROVIDING SYSTEM, INFORMATION PROCESSING DEVICE, AND NON-TRANSITORY COMPUTER-READABLE MEDIUM

(71) Applicant: FUJI XEROX CO., LTD., Tokyo (JP)

(72) Inventor: Yasuyuki HIGUCHI, Kanagawa (JP)

(73) Assignee: FUJI XEROX CO., LTD., Tokyo (JP)

(21) Appl. No.: 15/054,535

(22) Filed: Feb. 26, 2016

(30) Foreign Application Priority Data
Jul. 17, 2015 (JP) 2015-143054

(51) Int. Cl. G06F 17/30

(52) U.S. Cl. CPC G06F 17/30522; G06F 17/30554; G06F 17/3056; G06F 17/30976

(57) ABSTRACT

In a question and answer information providing system, a question input that inputs a question regarding a site from a first user. An acquisition unit acquires first usage status information indicating a status of the first user's site usage. A question and answer collection storage unit stores question and answer information including the question, an answer to the question, and the acquired first usage status information. A request input unit inputs a request for the question and answer information from a second user. A controller controls to output the question and answer information in response to the request. The usage status information acquisition unit acquires second usage status information indicating a status of the second user's site usage, and the controller controls so that the question and answer information is displayed in a case where usage information of the first user matches usage information of the second user.

### CROSS-REFERENCE TO RELATED APPLICATIONS

This application is based on and claims priority under 35 USC 119 from Japanese Patent Application No. 2015-143054 filed Jul. 17, 2015.

### BACKGROUND

Technical Field

The present invention relates to a question and answer information providing system, an information processing device, and a non-transitory computer-readable medium.

### SUMMARY

According to an aspect of the invention, there is provided a question and answer information providing system including: a site; a question input, unit that inputs a question regarding the site from a first user of the site; an acquisition unit that acquires first usage status information indicating a status of the first user's usage of the site; a question and answer collection storage unit in which is stored a plurality of question and answer information including the question, an answer to the question, and the acquired first usage status information of the first user, in association with each other; a request input unit that inputs a request for the question and answer information regarding the site from a second user; and a controller that controls to output at least one piece of the stored question and answer information in response to the request. The usage status information acquisition unit acquires second usage status information indicating a status of the second user's usage of the site, and the controller controls so that the question and answer information which is stored in association with the first usage status information is displayed in a case where usage information of the first user matches usage information of the second user.

### BRIEF DESCRIPTION OF THE DRAWINGS

An exemplary embodiment of the present invention mil be described in detail based on the following figures, wherein:

FIG. 1 is a block configuration diagram illustrating an exemplary embodiment of a question and answer information providing system according to the present invention;

FIG. 2 is a hardware configuration diagram of a server computer that forms an FAQ site according to an exemplary embodiment;

FIG. 3 is a diagram illustrating an example of the data structure of an operation log stored in an operation log database according to an exemplary embodiment;

FIG. 4 is a diagram illustrating an example of the data structure of an error log stored in as error log database according to an exemplary embodiment;

FIG. 5 is a diagram illustrating an example of the data structure of query information stored in a query database according to an exemplary embodiment;

FIG. 6 is a diagram illustrating an example of the data structure of an FAQ stored in an FAQ database according to an exemplary embodiment;

FIG. 7 is a diagram illustrating an example format of a screen displayed when accessing an FAQ site according to an exemplary embodiment;

FIG. 8 is a flowchart illustrating a process for a query according to an exemplary embodiment;

FIG. 9 is a flowchart illustrating an FAQ display process according to an exemplary embodiment; and

FIG. 10 is a diagram illustrating an example of an FAQ display screen displayed after an FAQ link is selected according to an exemplary embodiment.

### DETAILED DESCRIPTION

Hereinafter, an exemplary embodiment, of the present invention will be described on the basis of the drawings.

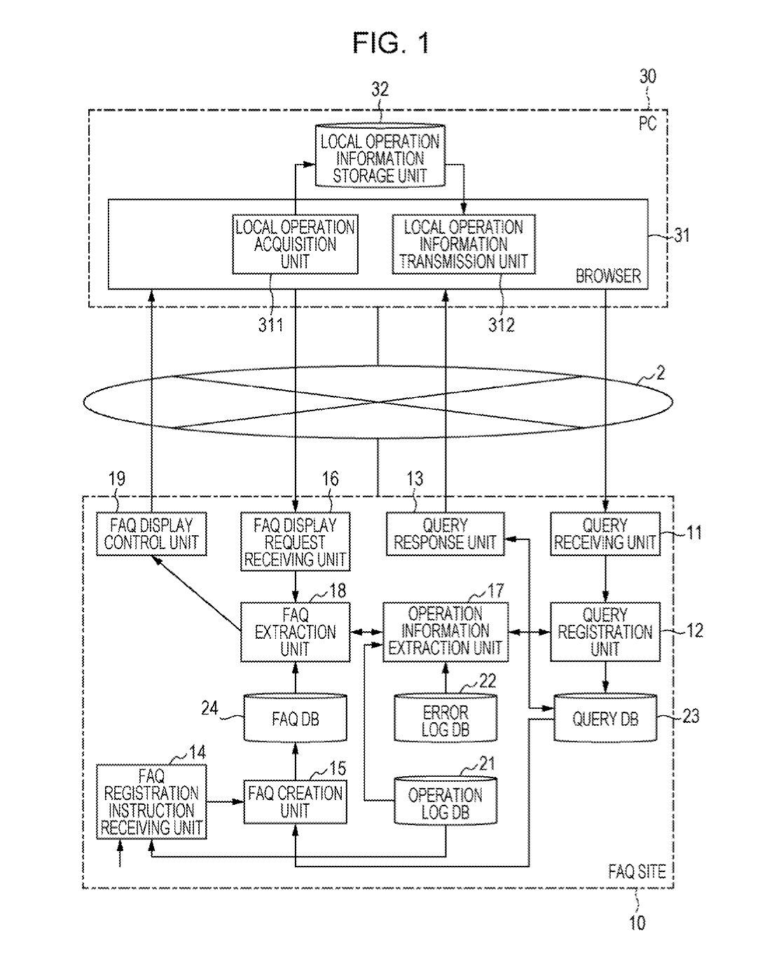

FIG. 1 is a block configuration diagram illustrating an exemplary embodiment of a question and answer information providing system according to the present invention. FIG. 1 illustrates a configuration in which an FAQ site 10 and a personal computer (PC) 30 are connected through a network 2. The FAQ site 10 according to the exemplary embodiment is realized by a server computer (information processing device), and functions as a portal site or provides FAQ functions. The PC 30 is a computer used by a user of the portal site of the FAQ site 10. The FAQ site 10 is utilized from multiple PCs 30, but since it is sufficient for each PC 30 to have similar functions, FIG. 1 illustrates only one PC 30.

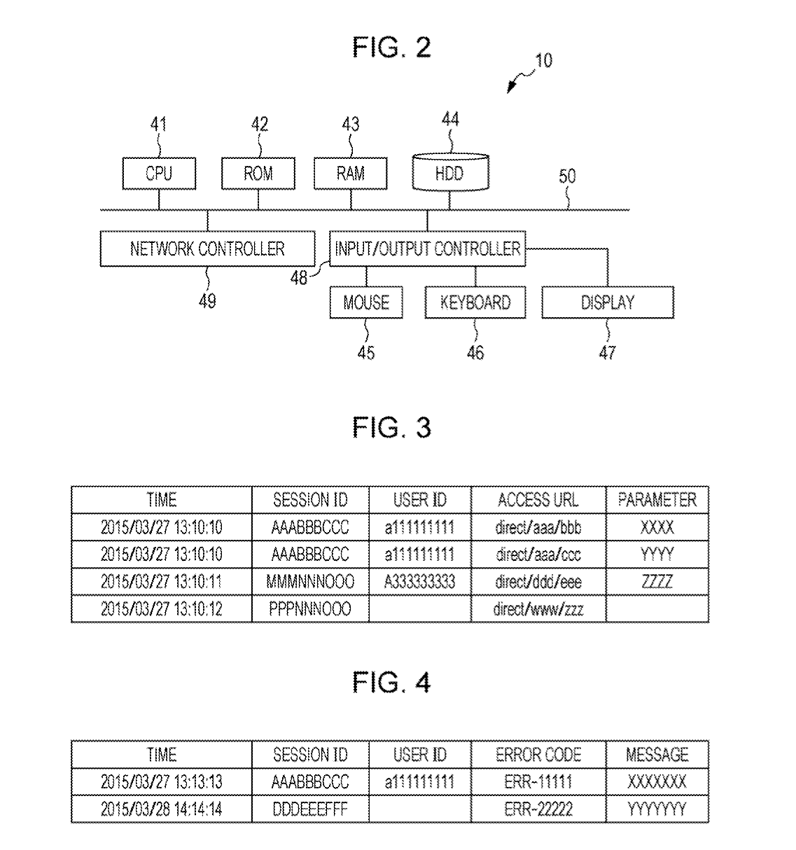

FIG. 2 is a hardware configuration diagram of a server computer that forms the FAQ site 10 according to the exemplary embodiment. In the exemplary embodiment, the computer that forms the FAQ site 10 may be realized by an existing general-purpose hardware configuration. In other words, the computer is configured by a CPU 41, ROM 42, RAM 43, a hard disk drive (HDD) 44, an input/output controller 48 that respectively connects a mouse 45 and a keyboard 46 provided as input devices and a display 4 provided as a display device, and a network controller 49 provided as a communication device, the above components being interconnected by an internal bus 50. Not that since the PC 30 is also a computer, the hardware configuration may be configured similarly to FIG. 2.

Returning to FIG. 1, the FAQ site 10 according to the exemplary embodiment, includes a query receiving unit 11, a query registration unit. 12,. a query response unit 13, an FAQ registration instruction receiving unit 14, an FAQ creation unit 15, an FAQ display request receiving unit 16, an operation information extraction unit 17, an FAQ extraction unit 18, an FAQ display control unit 19, an operation log database (DB) 21, an error log database (DB) 22, a query database (DB) 23, and an FAQ database (DB) 24. Note that structural elements not used in the description of the exemplary embodiment are omitted from FIG. 1. This applies similarly to the PC 30.

The query receiving unit 11 receives and accepts a query request from a user using the PC 30. At this point, the query receiving unit 11 functions as a query usage status information acquisition unit, that acquires usage status information related to the status of the user's usage of the FAQ site 10. The query registration unit 12 is provided as a query information registration unit, and by referencing the usage status information acquired by the query receiving unit 11, the query registration unit 12 acquires, as usage status information, query usage information indicating the usage results of the FAQ site 10 from the time when the relevant user started accessing the FAQ site 10 up until the relevant query request was made. Subsequently, query information, which includes a question indicating the content of the query by the user who made the query request, and the acquired usage status information, is created and registered in the query database 23. When an answer to the question is obtained in response to the query request from the user, the query response unit 13 responds to the relevant user with the answer.

The FAQ registration instruction receiving unit 14 receives an instruction to register an FAQ in the FAQ database 24 by an FAQ administrator or the like. The FAQ creation unit 15 is provided as a question and answer information registration unit, and from among query information including an answer to the question out of query information stored in the query database 23, the FAQ creation unit 15 registers query information selected by the FAQ administrator or the like in the FAQ database 24 as question and answer information.

The FAQ display request receiving unit 16 receives and accepts a request to display an FAQ stored in the FAQ database 24 from a user using the PC 30. At this point, the FAQ display request receiving unit 16 functions as a usage status information acquisition unit that acquires usage status information indicating the status of the user's usage of the FAQ site 10. The operation information extraction unit 17 retrieves operation information corresponding to the usage status information from the operation log database 21. Similarly, the operation information extraction unit 17 retrieves error information corresponding to the usage status information from the error log database 22. The FAQ extraction unit 18 is provided as an extraction unit, and by referencing the usage status information acquired by the FAQ display request receiving unit 16, the FAQ extraction unit 18 acquires, from the FAQ database 2A, an FAQ including usage status information matching the usage information indicating the usage results of the FAQ site 10 from the time when the relevant user started accessing the FAQ site 10 up until the relevant display request was made. The FAQ display control unit 19 is provided as a controller, causing the PC 30 used by the relevant user to display the FAQ extracted by the FAQ extraction unit 18.

FIG. 4 is a diagram illustrating an example of the data structure of an operation log stored in the operation log database 21 according to the exemplary embodiment. The PC 30 transmits a Hypertext Transfer Protocol (HTTP) request (hereinafter simply designated “request”) for making a query according to the query request from the user, and the FAQ site 10 replies to the request with an HTTP response (hereinafter simply designated “response”). The browser 31 interprets the response to form and display a display screen on the display of the PC 30. In the operation log database 21, the result of the user accessing the FAQ site 10 from the PC 30, or in other words, a log of operations performed on the screen displayed on the PC 30 based on the response from the FAQ site 10, is recorded as operation information. More specifically, among operations performed on the displayed screen, operation information based on operations detected by a request transmitted to the FAQ site 10 in conjunction with the operations is recorded. Mote that since accessing the FAQ site 10 involves performing some kind of operation on a screen displayed on the PC 30, in the exemplary embodiment, the terms “accessing” the FAQ site 10, “using” the FAQ site 10, and “performing operations” on a display screen are used near-synonymously. The operation information includes the time when an operation was performed, a session ID identifying the session established with the PC 30, a user ID identifying the user who performed the operation, and an access URL indicating the page operated by the user. If parameters were attached during the operation, the parameters are included. In the exemplary embodiment, an existing operation log database 21 may be used as-is.

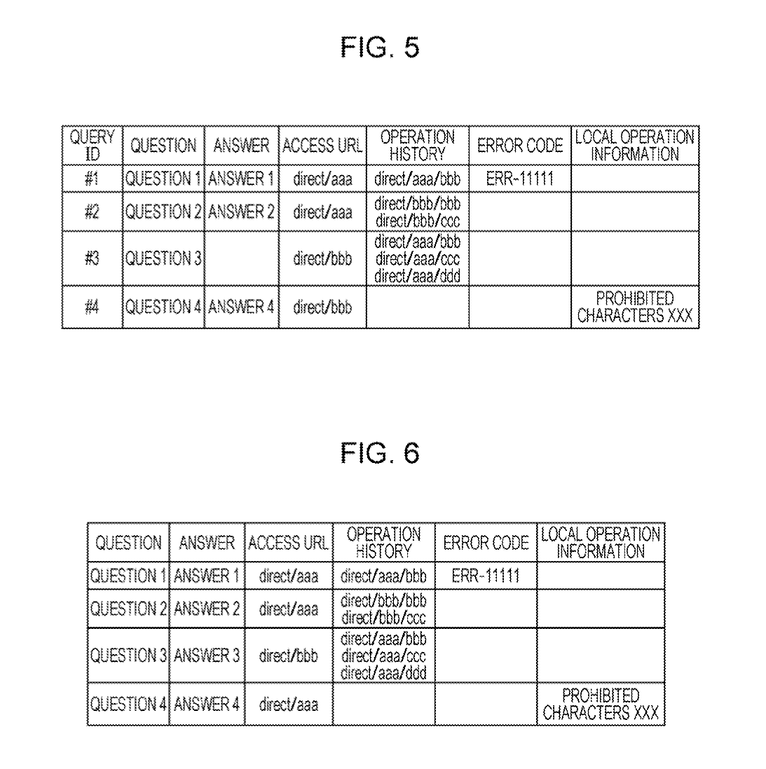

FIG. 5 is a diagram illustrating an example of the data structure of an error log stored in the error log database 22 according to the exemplary embodiment. In the error log database 22, error information related to an error that occurred when the user accessed the FAQ site 10 from the PC 30 is recorded. The error information includes the time when the error occurred a session ID identifying the session established with the PC 30 whose access produced the error, a user ID identifying the user who produced the error, an error code identifying the produced error, and a message expressing the relevant error. In the exemplary embodiment, an existing error log database 22 may be used as-is.

FIG. 6 is a diagram illustrating an example of the data structure of query information stored in the query database 23 according to the exemplary embodiment. The query database 23 according to the exemplary embodiment is provided as a query information storage unit. In the query database 23, when a user makes a query from the PC 30, information related to the query is recorded. The query information includes a query ID for identifying each query, a question asked by the user with respect to the FAQ site 10, the answer if the relevant question was answered, and usage status information related to the usage of the FAQ site 10 from the time when the relevant user started accessing the FAQ site 10 up until the relevant question was asked. The usage status information according to the exemplary embodiment includes the URL (access DHL) that was being accessed (displayed on-screen) when the user made the query, and the URLs accessed from the time when the user started accessing the FAQ site 10 up until the relevant question was asked (operation log). If an error code was specified in the query, the error code and local operation information attached to the query from the PC 30 are included in the usage status information.

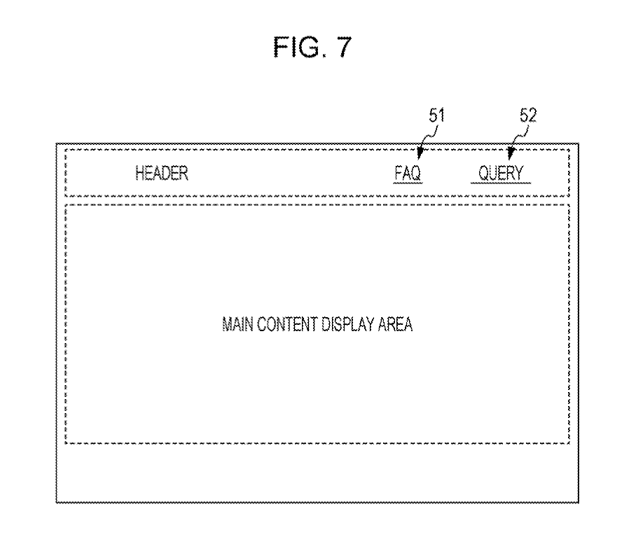

FIG. 7 is a diagram illustrating an example of the data structure of an FAQ stored in the FAQ database 24 according to the exemplary embodiment. The FAQ database 24 according to the exemplary embodiment is provided as a question and answer collection storage unit. Stored in the FAQ database 24 is query information that an FAQ administrator or the like has decided to register in the FAQ database 34 from among the query information stored in the query database 23. Since the query information registered in the query database 23 does not include answers until answers are provided by an FAQ administrator, a supervisor, or the like, whereas the FAQ database 24 includes both query content (questions) and answers, in the exemplary embodiment, the different terms “question and answer information” and “query information” registered in the query database 23 are used.

If “Q&A” is used to denote a pair of a query (question) and a corresponding answer to the query, then the FAQ database 24 is a collection of such Q&A information. The FAQ database 24 or a function that provides “frequently asked questions” is typically called an “FAQ”. In the exemplary embodiment, for the sake of convenience, a Q&A registered in the FAQ database 24 will also be called an “FAQ”. The data structure of an FAQ registered in the FAQ database 24 is similar to that of the query information stored in the query database 23, except for the query ID.

Each of the structural elements 11 to 19 in the FAQ site 10 is realized by cooperative action between the computer that forms the FAQ site 10 and a program running on the CPU 41 installed in the computer. Additionally, each of the storage units 21 to 24 is realized by the HDD 44 installed in the FAQ site 10. Alternatively, the RAM 43 may be used, or an external storage unit may be used over a network.

The PC 30 includes a local operation acquisition unit 311 and a local operation information transmission unit 312 that function while the browser 31 is being executed, and a local operation information storage unit 32. The local operation acquisition unit 311 functions as an operation information acquisition unit that acquires, from among operations performed since the user started accessing the FAQ site 10, operation information related to operations for which information about the operations is not transmitted to the FAQ site 10, and stores the acquired operation information in the local operation information storage unit 32 as local operation information. The “operations not-transmitted to the FAQ site 10”, or in other words “local operations”, will be described in detail together with the description of operation. The local operation information transmission unit 312 functions as an operation information transmission unit that retrieves and transmits local operation information from the local operation information storage unit 32 when transmitting an FAQ display request to the FAQ site 10.

The browser 31 on the PC 30 is realized by cooperatives action with a program running on a CPU installed in the PC 30. Additionally, the local operation information storage unit 32 is realized by an HDD installed in the PC 30. Alternatively, RAM may be used, or an external storage unit may be used over a network.

In addition, a program used in the exemplary embodiment obviously may be provided via a communication medium, and may also be provided be being stored on a computer-readable recording medium such as CD-ROM or USB memory. A program provided from a communication medium or a recording medium is installed onto a computer, and various processes are realized by having the CPU of the computer sequentially execute the program.

Next, operation according to the exemplary embodiment will be described.

When a user uses the PC 30 to access the FAQ site 10, the browser 31 interprets a response transmitted from the FAQ site 10 to display a page on the display. In the header of the page, an FAQ link 51 and a query link 52 are set as inserted hyperlinks, and thus the respective character strings “FAQ” and “Query” are selectably displayed on the display.

The user navigates to a page prepared by the FAQ site 10 for a desired objective, or provides some kind of input Into a page input field. In the case of an instruction operation with respect to the FAQ site 10, such as moving to another page, the browser 31 transmits a request to the FAQ site 10. Consequently, on the FAQ site 10, the content of operations by the user may be detected, and the operation content is recorded in the operation log database 21 as operation information. Note that in the header of the request, the session ID, a user ID if the user is logged in, and a URL indicating the page being displayed on the PC 30 when the FAQ site 10 was accessed (entry point) are set as usage status information indicating the usage status of the relevant user, and thus operation information is generated on the basis of this information. Subsequently, the browser 31 interprets a response transmitted in reply to the transmitted request, and displays a page on-screen. However, for some operations, a request is not transmitted to the FAQ site 10.

For example, if an operation of inputting prohibited characters into an input field is performed (such as inputting letters into an input field set to accept only numerals), the input is rejected, but in such cases, the operation is processed (in this example, the input is rejected) locally on the PC 30 without a request being transmitted, to the FAQ site 10. In this way, an operation that is not recognized fey the FAQ site 10 because the operation is handled locally by the PC 30 is called a “local operation” in the exemplary embodiment. Local operations are not recorded in the operation log database 21, even operations on pages provided by the FAQ site 10.

When a local operation is performed by the user, the local operation acquisition unit 311 temporarily stores operation information related to the operation, such as the content of the local operation, the time when the operation was performed, the user ID of the user who performed the operation, and the session ID, in the local operation information storage unit 32 as local operation information.

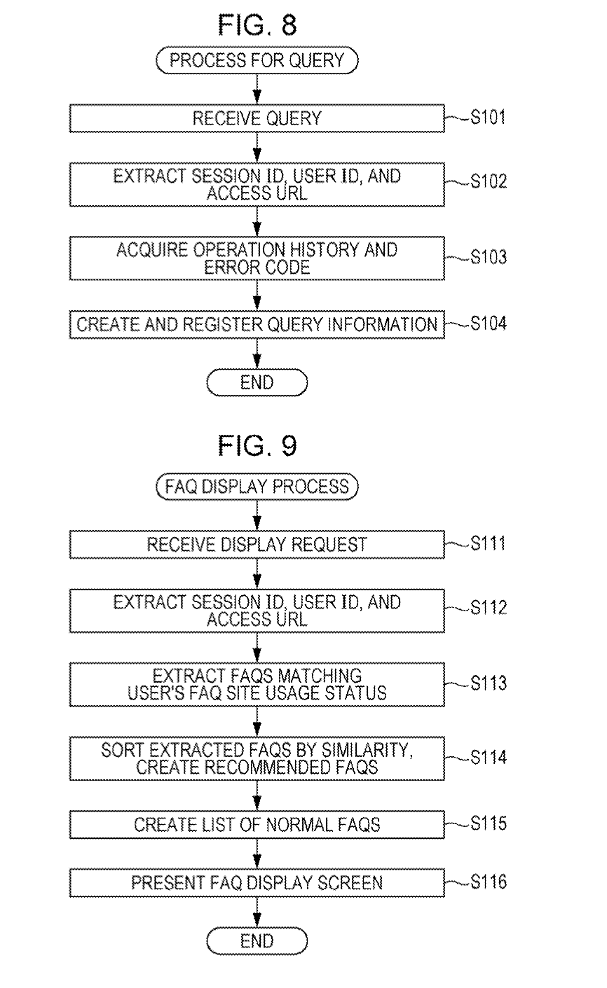

Hereinafter, a process for a query that is executed by the FAQ site 10 when a query request is transmitted from the PC 30 will be described using the flowchart illustrated in FIG. 8.

While using the FAQ site 10, if the user desires to make some kind of query to the FAQ site 10, the user clicks the query link 52. Consequently, a prescribed query screen is displayed, and the user enters the content of the query (question) into a prescribed field on the query screen and then executes the query.

When the user executes a query, the PC 30 transmits a request for the query request to the FAQ site 10. At this point, if local operation information for the relevant user is stored in the local operation information storage unit 32, the local operation information transmission unit 312 retrieves the local operation information, and attaches the local operation information to the request. Note that the local operation information may also be deleted after transmission to the FAQ site 10.

When the query receiving unit 11 receives a query request transmitted from the PC 30 (step 101), the query registration unit 12 creates query information. To do so, the query registration unit 12 extracts the respective usage status information of the session ID, the user ID, and the URL that was being accessed at the time of the request (access URL) from the header of the query request received by the query receiving unit 11 (step 102). Note that a query may be made without logging in. Consequently, a user ID Is acquired if the user is logged in, but is not acquired if the user is not logged in. Furthermore, if local operation information is attached to the request, the query registration unit 12 acquires the local operation information.

Next, in step 103, the operation information extraction unit 17 acquires information to include in the query information from the operation log database 21 and the error log database 22. In other words, the operation information extraction unit 17 searches the operation log database 21 using the session ID extracted from the request header as the search key, and extracts the access URL from the most recent operation information with a matching session ID. Also, if a user ID is successfully extracted from the request header, the operation information extraction unit 17 searches the operation log database 21 using the relevant user ID as the search key, and extracts the access URL from the most recent operation information with a matching user ID. Subsequently, the extracted URLs are merged and sorted chronologically to obtain an operation history.

Additionally, the operation information extraction unit 17 searches the error log database 22 using the session ID as the search key, and extracts the error code from the most recent operation information with a matching session ID. Also, if a user ID is successfully extracted from the request header, the operation information extraction unit 17 searches the error log database 22 using the relevant user ID as the search key, and extracts the error code from the most recent operation information with a matching user ID. The extracted error codes are then merged.

Note that in the exemplary embodiment, when obtaining an operation history and error codes, the most recent operation information is treated as the extraction source, but the term “most recent” will be described later.

Next, the query registration unit 12 extracts from the operation log database 21 the content of the query (question) included in the received query and the access URL extracted from the query, groups the extracted information with the merged operation history, the error codes extracted from the error log database 22, and the attached local operation information if present, and assigns a query ID for identifying and distinguishing the grouped information from other query information to thereby create query information. Subsequently, the query registration unit 12 registers the created query information in the query database 23 (step 104).

Note that if an administrator of the FAQ site 10 or the like creates an answer to a query from a user, the query response unit 13 registers the answer in the corresponding query information, and also responds to the user who made the query.

Query information is thus created as above every time a user makes a query. Next, an FAQ registration process according to the exemplary embodiment will be described.

When an FAQ administrator requests the registration of an FAQ by performing a prescribed operation at an arbitrary timing, the FAQ registration instruction receiving unit 14 displays, on a display 47, query information registered in the query database 23 according to the request. The FAQ administrator chooses query information considered to be suitable for additional registration in the FAQ database 24 from among the displayed query information, or in other words, query information considered to be a “frequently asked question”.

When the FAQ registration instruction receiving unit 14 receives query information chosen by the FAQ administrator, the FAQ creation unit 15 removes the query ID from the query information received by the FAQ registration instruction receiving unit 14, and then registers the query information in the FAQ database 24. Note that since this query information is made available for public viewing, unlike when the query information was registered in the query database 23, the FAQ registration instruction receiving unit 14 may also display questions and answers in an editable format to enable the FAQ administrator to check and edit the displayed content.

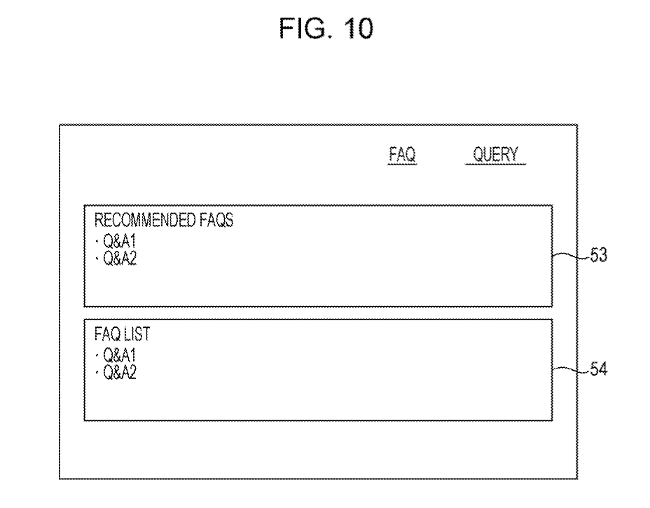

Next, an FAQ display process according to the exemplary embodiment will be described using the flowchart illustrated in FIG. 9.

The user, while using the PC 30 to access the FAQ site 10, clicks the FAQ link 51 illustrated in FIG. 7. The browser 31 transmits a request for FAQ display according to an FAQ display request from the user, and similarly to the case of making a query, if local operation information for the relevant user is stored in the local operation information storage unit 32, the local operation information transmission unit 312 retrieves the local operation information, and attaches the local operation information to the request.

When the FAQ display request receiving unit 16 receives an FAQ display request transmitted from the PC 30 (step 111), the FAQ extraction unit 18 extracts the respective usage status information of the session ID, the user ID if included, and the URL that was being accessed at the time of the request (access URL) from the header of the request expressing the display request received by the FAQ display request receiving unit 16 (step 112). In addition, if local operation information is attached, the local operation information is also extracted as usage status information.

Next, in step 113, the FAQ extraction unit 18 extracts, from the FAQ database 24, an FAQ matching the user's usage status Of the FAQ site 10. To do so, the operation information extraction unit 17 searches the operation log database 21 using the session ID extracted from the request header as the search key, and extracts the access URL from the most recent operation information with a matching session ID. Also, if a user ID is successfully extracted from the request header, the operation information extraction unit 17 searches the operation log database 21 using the relevant user ID as the search key, and extracts the access URL from the most recent operation information with a matching user ID. Subsequently, the extracted URLs are merged and sorted chronologically to obtain access URL list information.

Additionally, the operation information extraction unit 17 searches the error log database 22 using the session ID as the search key, and extracts the error code from the most recent operation information with a matching session ID. Also, if a user ID is successfully extracted from the request header, the operation information extraction unit 17 searches the error log database 22 using the user ID as the search key, and extracts the error code from the most recent operation information with a matching user ID. The extracted error codes are then merged.

According to the above, there is obtained usage information that includes usage status information as well as usage results of the FAQ site 10 in accordance with the usage conditions of the user who made the FAQ display request.

Next, the FAQ extraction unit 18 searches the FAQ database 24 using the access URL extracted from the request header as the search key, and extracts an FAQ set with an access URL matching the relevant access URL. For example, according to the example configuration of the FAQ database 24 illustrated in FIG. 6, when the access URL extracted from the request header is “direct/aaa”, the questions 1, 2, and 4 are extracted from the FAQ database 24.

In addition, the FAQ extraction unit 18 searches the FAQ database 24 using an error code extracted on the basis of the session ID (and user ID) in the above process as the search key, and extracts an FAQ set with an error code matching the relevant error code. For example, according to the example configuration of the FAQ database 24 illustrated in FIG. 6, when the error code is “ERR-11111”, the question 1 is extracted from the FAQ database 24. Note that if an error code is not extracted, no FAQ is extracted by this process.

In addition, if local operation information is attached to the display request, the FAQ extraction unit 18 searches the FAQ database 24 using the local operation information as the search key, and extracts an FAQ set with local operation information matching the relevant local operation information. For example, according to the example configuration of the FAQ database 24 illustrated in FIG. 6, when the local operation information is “Prohibited characters XXX”, the question 4 is extracted from the FAQ database 24. Note that if local operation information is not attached, no FAQ is extracted by this process.

According to the above, an FAQ are extracted on the basis of the access URL, the error code, and the local operation information, but an FAQ may also be extracted on the basis of any one of the above.

Meanwhile, multiple FAQs may be extracted by the above process in some cases. At this point, the FAQ extraction unit 18 compares each operation history set in the extracted FAQs and the access URL list information obtained from the operation log database 21 on the basis of the session ID (and user ID), and sorts the FAQs in order of highest similarity (step 114). The similarity of each FAQ is determined as follows.

First, suppose that a complete match between the operation history set in the extracted FAQ and the access URL list information has a similarity of 100%. Next, if the operation history is greater or less than the access URL list information, a ratio indicating the degree of excess or deficiency is subtracted from 100%. For example, if four access URLs are recorded as the operation history, and three access URLs are included in the access URL list information, the similarity becomes 75%, whereas if six access URLs are included (with four matching), the similarity becomes 50%.

The FAQ extraction unit 18 creates, as recommended FAQs, an FAQ list obtained by sorting FAQs conforming to the user's usage status of the FAQ site 10 in order of similarity as above.

In addition, if recommended FAQs hypothetically are not created, or even if recommended FAQs are created, the FAQ extraction unit 18 creates a normal FAQ list using existing functionality (step 115).

The FAQ display control unit 19 provides FAQs to the user by transmitting to the PC 30, in reply to the FAQ display request (request), an FAQ display screen (response) displaying the recommended FAQs and the normal FAQ list created by the FAQ extraction unit 18 (step 116).

FIG. 10 illustrates an example of an FAQ display screen displayed on the PC 30 as a result of the browser 31 interpreting a response. As illustrated by the example of FIG. 10, in the exemplary embodiment, recommended FAQs 53 are provided separately from a normal FAQ list 54 provided like in the past. In the recommended FAQs 53, there are presented FAQs obtained by referencing the conditions of who the user used the site, such as what operations the user performed on pages provided by the FAQ site 10, the order in which the user moved among pages, and what, errors occurred during usage, and extracting FAQs corresponding to cases in which the same operations are performed, the same pages are navigated, or the same errors occur. In other words, FAQs conforming to the usage status of the user who made the FAQ display request are provided.

The term “most recent” will now be described. To obtain the characteristic recommended FAQs 53 in the exemplary embodiment discussed above, the conditions of the user's site usage are referenced, as described above. Herein, the period over which to obtain the conditions of the user's site usage is expressed as the “most recent” n the above description. Conceivably, there is a high likelihood that the user will reference an FAQ because the user has though of some kind of question or query related to an accessed page, an operation on a page, or an error that occurred between the time when the user started accessing the FAQ site 10 up until the user clicked the FAQ link 51 and transmitted a question to the FAQ site 10. Consequently, in the exemplary embodiment, the usage conditions of the FAQ site 10 by an individual user between the time when that user started accessing the FAQ site 10 up until the user transmitted a question to the FAQ site 10 are acquired and referenced in order to create and provide recommended FAQs. In other words, the term “most recent” used in the exemplary embodiment refers to the most recent usage of the FAQ site 10, or more specifically, the time between when the user started accessing the FAQ site 10 up until the user transmitted a question to the FAQ site 10.

To determine the commencement of the “most recent” (the start point of access to the FAQ site 10 (usage start point)), in the exemplary embodiment, the session ID and the user ID are used. Since the start point may be specified if the user logs in to the FAQ site 10, in the exemplary embodiment, the user ID is used to search the operation log database 21 and the error log database 22. In the operation log database 21, operation information from when the user previously logged into the FAQ site 10 may be included. Obviously, operation information from when the user previously logged in may also be referenced, However, when the user previously logged in, the user may have already used the FAQ function to address a problem. Accordingly, in the exemplary embodiment, to exclude operation information from when the user previously logged in, the commencement or the “most recent” is limited to being a prescribed time period extending back from the current time, such as the last 30 minutes or the last 24 hours, for example. This applies similarly to the error log database 22.

In addition, since FAQ sites 10 that allow the display of FAQs without logging in also exist, in the exemplary embodiment, the session ID of the session established at the start point of accessing the FAQ site 10 is used. In the case of a FAQ site 10 that requires a login for FAQ display, if is sufficient, to use only the user ID.

The above also applies when creating the query information that acts as the basis for an FAQ. In other words, when creating query information according to a query request from a user, the usage status information of the query information is created by referencing usage conditions, such as operations performed between the time when the user started accessing the FAQ site 10 up until the user clicked on the query link 52 and transmitted a question to the FAQ site 10.

Note that although the exemplary embodiment describes FAQs provided by an FAQ site 10 as an example, the question and answer information is not limited to being an FAQ, and the exemplary embodiment is also applicable to question and answer information providing systems that provide information combining questions and answers, also called Q&A.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents

What is claimed is:

1. A question and answer information providing system comprising:
a site;
a question input unit that inputs a question regarding the site from a first user of the site;
an acquisition unit that acquires first usage status information indicating a status of the first user's usage of the site;
a question and answer collection storage unit in which is stored a plurality of question and answer information including the question, an answer to the question, and the acquired first usage status information of the first user, in association with each other;
a request input unit that inputs a request for the question and answer information regarding the site from a second user; and
a controller that controls to output at least one piece of the stored question and answer information in response to the request, wherein
the usage status information acquisition unit acquires second usage status information indicating a status of the second user's usage of the site, and
the controller controls so that the question and answer information which is stored in association with the first usage status information is displayed in a case where usage information of the first user matches usage information of the second user.

2. The question and answer information providing system according to claim 1, further comprising:
an information terminal device which is used by the first and second users, the information terminal device including
an operation information acquisition unit that acquires operation information related to operations for which information related to the operations is not transmitted to the site, from among operations performed since the user started accessing the site, and
an operation information transmission unit that transmits the operation information when transmitting the request to the site, and
the usage status information acquisition unit acquires operation information transmitted from the operation information transmission unit as all or part of the first or second usage status information.

3. The question and answer information providing system according to claim 1, wherein
the first or the second usage information includes error information related to an error produced due to the first or the second user's operation with respect to the site.

4. The question and answer information providing system according to claim 1, wherein
the controller controls so that the plurality of question and answer information is displayed in order of similarity of the first and second usage information.

5. An information processing device comprising:
a usage status information acquisition unit that, according to a request from a second user of a site for question and answer information regarding a site stored in a question and answer collection storage unit in which is stored a plurality of the question and answer information including a question regarding the site from a first user of the site, an answer to the question, and first usage status information of the first user, in association with each other, acquires second usage status information indicating a status of the second user's usage of the site;
an extraction unit that, by referencing the second usage status information acquired by the usage status information acquisition unit, extracts from the question and answer collection storage unit question and answer information stored in association with the first usage status information in a case where usage information of the first user matches usage information of the second user indicating a result of using the site around the time when the second user accessed the site; and
a controller that controls to output the question and answer information extracted by the extraction unit in response to the request.

6. A non-transitory computer-readable medium storing a program causing a computer to execute a process for providing question and answer information, the computer being able to access a question and answer collection storage unit in which is stored a plurality of the question and answer information including a question regarding a site from a first user of the site, an answer to the question, and first usage status information of the first user, in association with each other, the process comprising:
acquiring, according to a request from, a second user of the site for the question and answer information regarding the site stored in the question and answer collection storage unit, second usage status information indicating a status of the second user's usage of the site;
by referencing the acquired second usage status information, extracting from the question and answer collection storage unit question and answer information stored in association with the first usage status information in a case where usage information of the first user matches usage information of the second user indicating a result of using the site around the time when the second user accessed the site; and
controlling to output the question and answer information extracted by the extraction unit in response to the request.
